(19) United States
(12) Patent Application Publication
(10) Pub. No.: US 2002/0141697 A1
(43) Pub. Date: Oct. 3, 2002

(54) Variable group delay unit and variable group delay optical fiber module

(76) Inventors: Daeyoul Yoon, Tokyo (JP); Hiroshi Matsuura, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/040,957

(22) Filed: Jan. 2, 2002

(30) Foreign Application Priority Data
Feb. 9, 2001 (JP) 2001-034092

(51) Int. Cl. G02B 6/26; G02B 6/32

(52) U.S. Cl. 385/31; 385/33; 385/27

(57) ABSTRACT

Through spacing to each other, provided are an input/output waveguide element for introducing and deriving light and a light reflecting element for reflecting light. The light introduced by the input/output waveguide element is reflected by the reflecting element and returned to the input/output waveguide element. On a path of the light, a first lens, a multiple reflecting device and a second lens are provided with a spacing to one another. A multiple reflecting device has a first interface facing to the first lens and a second interface, or a surface opposite thereto, parallel with each other. The light entered the multiple reflecting device is multiplex-reflected upon the first interface and second interface depending upon a wavelength of the light. The multiple reflecting device has a third interface as a slant surface having an angle to the first interface of greater than 90° and smaller than 180°.

### BACKGROUND OF THE INVENTION

1. Field of the Invention

The present invention relates to a variable group delay unit and variable group delay optical module for use in the field of optical communication systems, optical measurements and so on.

2. Description of the Related Art

In the optical communications using optical fibers, it is a recent situation that there is difficulty in meeting the requirement of transmission on a single wavelength because of increase in information amount. For this reason, the wavelength multiplexing transmission has been proposed and placed in practical application wherein a plurality of intensity modulated portions of light different in wavelength are multiplexed into a wavelength-multiplexed light so that the wavelength-multiplexed light can be transmitted over one optical fiber thereby increasing transmission capacity.

However, where the intensity-modulated signal light is input to the optical fiber, propagation velocity is different depending upon a wavelength of the transmission light over the optical fiber. Due to the occurrence of chromatic dispersion, input light to the optical fiber turns to an output having a different waveform from that of the input through transmission over the optical fiber.

Meanwhile, where transmitting a digitized transmission signal by light intensity modulation, as transmission distance increases the waveform pulse width increases. This makes it impossible to distinguish from adjacent pulses, resulting in a problem of readily causing error.

The dispersion effect increases as pulse width is narrowed in order to raise transmission rate of signal light. In high bit-rate optical communication, there is a need to compensate for dispersion with accuracy by decreasing the dispersion quantity of the optical fiber itself or connecting the optical fiber with a dispersion-compensating optical fiber module having a characteristic reverse to that of the dispersion quantity of the optical fiber.

The dispersion-compensating optical fiber module is to be applied with a multi-staged combination of a dispersion-compensating optical fiber (DCF), a dispersion-compensating grating (DCG), and a Mach-Zehnder interference type optical element of a planer optical waveguide circuit, or the like.

However, where the dispersion-compensating as above is used to compensate for dispersion, there is a need to fabricate a dispersion-compensating module while adjusting and setting the quantity of dispersion every time in order to obtain an optimal compensation quantity for a required compensation amount.

The present invention has been made in order solve the problem in the related art, and it is an object to provide a variable group delay unit and variable group delay optical module easy to fabricate and can be preferably varied in dispersion amount.

### SUMMARY OF THE INVENTION

In order to achieve the above object, the present invention has means to solve the problem by the following structure. Namely, a variable group delay unit of a first invention comprises: an input/output waveguide element for introducing and deriving light; a light reflecting element arranged with a spacing to the input/output waveguide element to reflect light; a multiple reflecting device provided on an optical path that a light introduced by the input/output waveguide element reflects upon the light reflecting element and returns to the input/output waveguide element; a first lens provided on the optical path at between the multiple reflecting device and the input/output waveguide element; and a second lens provided on the optical path at between the multiple reflecting device and the light reflecting element; whereby the multiple reflecting device has a first surface facing to the first lens and a second interface as a surface opposite thereto that are parallel with each other to multiple-reflect a light incident on the multiple reflecting device by the first interface and second interface, the multiple reflecting device having as one end surface a third interface having a slant surface at an angle to the first interface of greater than 90 degrees and smaller than 180 degrees. This structure is means to solve the problem.

### BRIEF DESCRIPTION OF THE DRAWINGS

FIG. 1 is an essential-part structural view showing a first embodiment of a variable group delay unit;

FIG. 2 is an explanatory view showing a propagation state along a center axis in an optical axis direction of the light incident on a third interface of a multiple reflecting device in the above embodiment;

FIG. 3 is an explanatory view showing a propagation state of a ray of light propagating at an angle Δφ to a center axis in an optical axis direction of the light incident on the third interface of a multiple reflecting device in the above embodiment;

FIG. 4 is an explanatory view showing a propagation state that an exit light from the multiple reflecting device reflects upon a light reflecting element and returns to the multiple reflecting device in the above embodiment;

FIG. 5 is an explanatory view showing a relationship of an exiting position of an exit light from the multiple reflecting device and an optical path length in the above embodiment;

FIG. 6A is an explanatory view showing a spot form of an exit light from an input/output waveguide element in the above embodiment;

FIG. 6B is an explanatory view showing a spot form of an exit light from a collimate lens of a first lens;

FIG. 6C is an explanatory view showing a spot form of a light focused by an anamorphic lens of the first lens;

FIG. 7 is an explanatory view showing a method for fabricating a multiple reflecting device applied to the above embodiment;

FIG. 8 is an explanatory view showing another example of a method for fabricating a multiple reflecting device;

FIG. 9 is an explanatory view showing one embodiment of a variable group delay module having the variable group delay unit of the above embodiment;

FIG. 10 is an explanatory view showing a third embodiment of a variable group delay module according to the invention;

FIG. 11 is an explanatory view showing another embodiment of a variable group delay module according to the invention;

FIG. 12 is an explanatory view on the distance of between an incident-light incident position and a boundary E along the third interface in the case the first interface and the third interface are properly formed at angle on the multiple reflecting device; and

FIG. 13 is an explanatory view on the distance of between an incident-light incident position and a boundary E along the third interface in the case the first interface and the third interface are on the same plane on the multiple reflecting device.

### DETAILED DESCRIPTION

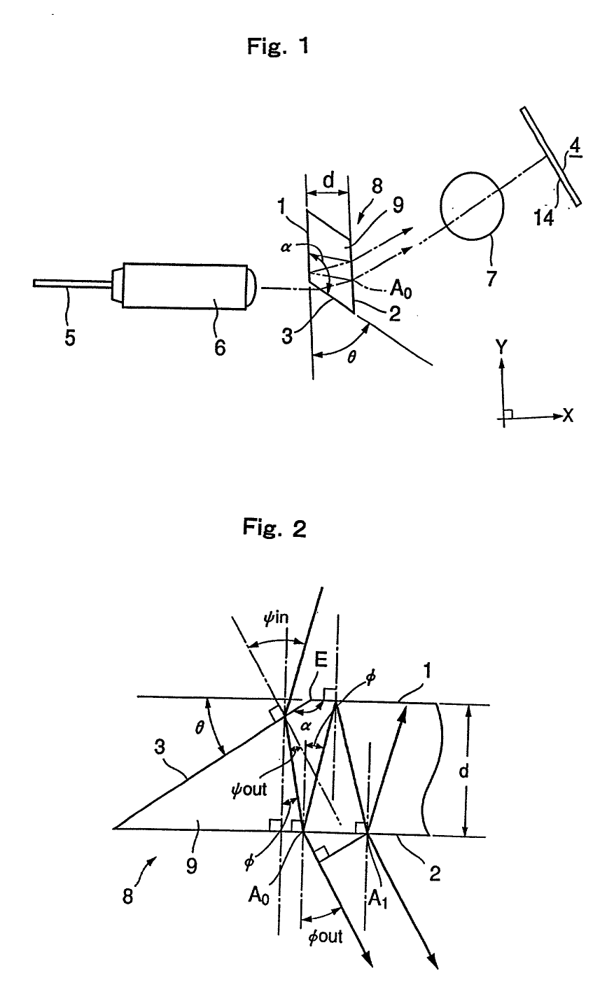

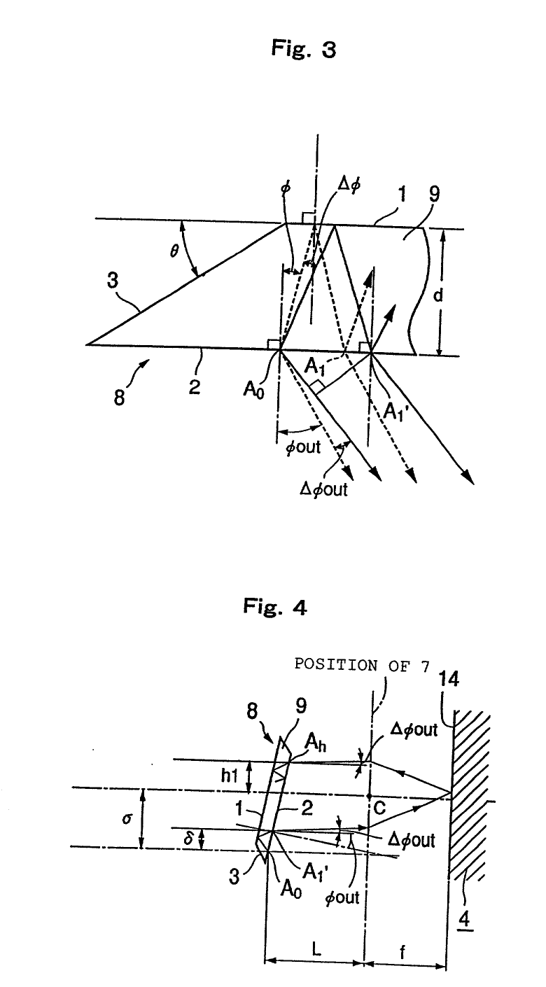

Embodiments of the present invention will be explained with reference to the drawings. FIG. 1 shows one embodiment of a variable group delay unit of the invention. As shown in the figure, this embodiment has an input/output waveguide element 5 for inputting and outputting light and a light reflecting element 4 arranged with a spacing from the input/output waveguide element 5. Meanwhile, a multiple reflecting device 8 is provided on an optical path that the light introduced by the input/output waveguide element 5 is reflected by the light reflecting element 4 and then returned to the input/output element 5.

Furthermore, a first lens 6 is provided on an optical path at between the multiple reflecting device 8 and the input/output waveguide element 5. A second lens 7 is provided on an optical path at between the multiple reflecting device 8 and the light reflecting element 4.

The first lens 6 and the second lens 7 are formed by properly combining one or more of a ball lens, a spherical lens, a graded refractive index (GRIN) lens, a aspherical lens, a cylindrical lens, a multi-mode graded fiber lens (MMFL) and a anamorphic prism. In this embodiment, the first lens 6 is a composite lens made up by a two kinds of lenses while the second lens 7 is formed by a spherical lens. The first and the second lenses 6, 7 each have a anti-reflection coating for a set wavelength formed on a surface that light is to be incident.

The input/output waveguide element 5 is formed by a single-mode optical fiber while the light reflecting element 4 is formed of a planar mirror. The light reflecting element 4 has a planar surface in a region on which an exit light from the lens 7 is incident (reflecting surface 14 in the figure). In this region is formed a reflecting film having a reflectance of 90% or higher for a set wavelength. The multiple reflecting device 8 is a light multiplexing reflecting plate having a substrate 9. The substrate 9 is formed of a glass material BK7.

The multiple reflecting device 8 has a first interface 1 facing to the lens 6 and a second interface 2, or the opposite surface, are parallel with each other. The first interface 1 and the second interface 2 has a distance d between them. The multiple reflecting device 8 is structured to multiple-reflecting the input light mutually between the first interface 1 and the second interface 2. In other words, the first interface 1 and the second interface 2 are made multiplexing-reflecting surfaces parallel with and opposite to each other.

The multiple reflecting device 8 has, as one end surface, a third interface 3 forming a slant surface having an angle α to the first interface 1. In this embodiment, the angle α is given a value of 160° that is fallen within a range of from 150° or greater to 175° or smaller.

A first reflecting film (not shown in the figure) is formed on the first interface 1 of the multiple reflecting device 8. The first reflecting film reflects 99% or more of a set wavelength of light. On the second interface 2, a second reflecting film (not shown in the figure) is formed. The second reflecting film has a reflectance of 60% or higher for a set wavelength of light. Also, the third interface 3 of the multiple reflecting device 8 is formed with a anti-reflection coating (not shown in the figure) for a set wavelength of light at least in a region to pass light.

In this embodiment, the light introduced by the input/output waveguide element 5 is incident on the third interface of the multiple reflecting device 8 through the first lens 6 and then exits at the second interface 2. The exit light is reflected by the light reflecting element 4 and the reflected light enters the second interface 2 and exit at the third interface 3.

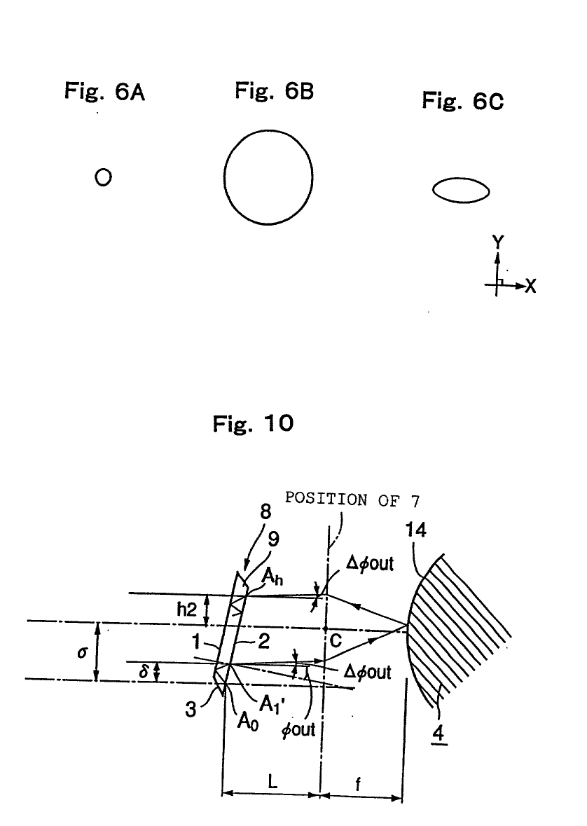

The exit light from the input/output waveguide element 5 is diverging light. Accordingly, assuming that the beam spot at the exit end of the input/output waveguide element 5 has a size/shape, for example, as shown in FIG. 6A, the diameter of beam spot gradually increases into a beam spot, for example, as shown in FIG. 6B, thus entering the first lens 6.

The composite lens structuring the first lens 6 has a collimate lens and anamorphic lens. The collimate lens, a lens for making the light exited from the input/output waveguide element 5 (diverging light) into collimate light, inputs light to the anamorphic lens without increasing the spot diameter.

The anamorphic lens is formed, for example, by a cylindrical lens. The anamorphic lens converts the beam spot, passed the collimate lens, having nearly a true-circular form into an elliptic or linear form as shown in FIG. 6C, and focus it such that the beam waist thereof nearly coincides with a position A₀ in FIG. 1 (position that the light is first incident on the second interface 2 from the third interface 3 of the multiple reflecting device 8).

In other words, by thus designing the structure and arrangement of the anamorphic lens, the anamorphic lens serves as a lens to make the beam spot diameter in an interference direction (Y direction the light travels while reflecting zigzag within the multiple reflecting device 8 as shown in FIG. 1, or 6) of the light traveling, smaller than that of the beam spot diameter in an orthogonal direction (X direction) to the interference direction.

The light, if made in an elliptic or linear form in the X direction by the anamorphic lens as above, can enhance the interference effect of light where the light travels while reflecting within the multiple reflecting device 8. Note that the spot diameter of light at a beam waist in an interference direction may be equivalent, for example, to that of a use wavelength, e.g. approximately 10 μm for a use wavelength of 1.3 μm.

In the meanwhile, in this embodiment, the multiple reflecting device 8 has a boundary E, shown in FIG. 2, between the first interface 1 and the third interface 3 (ridge formed by the first interface 1 and the third interface 3) that is inhomogeneous in film quality.

Incidentally, FIG. 2 is a view typically showing a principle of light separation by the multiple reflecting device 8 of this embodiment. This typically shows, by the bold line, a path that light is incident on the third interface 3 of the multiple reflecting device 8 to multiple-reflect within the multiple reflecting device 8 part of which light exits at the second interface 2. The optical path shown in the figure is a path that a center axis of light in a travel direction passes.

The exit light from the first lens 6, if incident on the film-quality inhomogeneous portion of the boundary E, causes transmission loss. Meanwhile, the light entering the multiple reflecting device 8 at the third interface 3 and reaching a position A₀ on the second interface 2, in part, exits at the position A₀. The remaining portion of light reflects upon the second interface 2 toward the first interface 1. Herein, if this reflection light enters the film-quality inhomogeneous portion of the boundary B, transmission loss will occur.

Accordingly, the film-quality inhomogeneous portion in the boundary B is desirably narrow. In this embodiment, the film-quality inhomogeneous portion is minimized by making the third interface 3 in a slant surface and properly forming the first interface 1 and the third interface 3 at a proper angle.

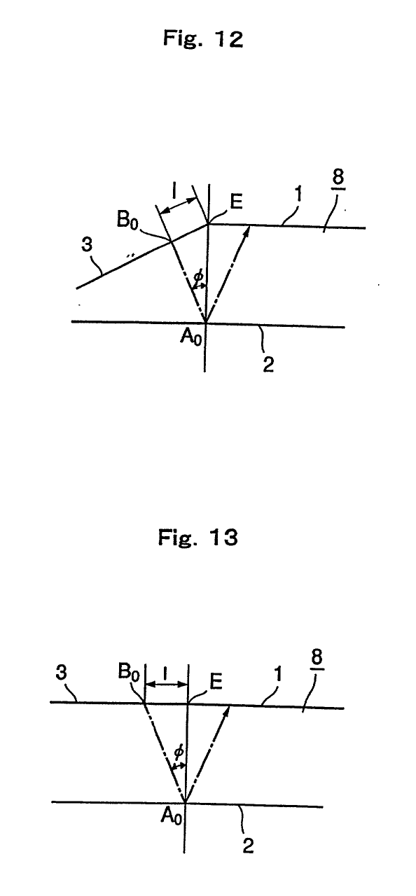

Meanwhile, in such a case that, as shown in FIG. 12, the boundary E as a ridge between the first interface 1 and the third interface 3 is positioned on a line vertical to the second interface passing the position A₀, provided, for example, that the multiple reflecting device 8 has a thickness d of 500 μm, an angle α is 150° and an incident angle φ of incident light on the second interface 2 is 5°, the distance l along the third interface of from an incident position B₀ of incident light on the third interface 3 to the boundary E is approximately 48 μm.

On the contrary, if the third interface 3 and the first interface are on the same plane as shown in FIG. 13, the distance l is approximately 44 μm where the other conditions are given the same as the case of FIG. 12. Accordingly, if the first interface 1 and the second interface 3 have a proper angle smaller than 180° (in this case 150°) as in the foregoing, an advantage is available that the incident light upon passing the third interface 3 is unlikely to undergo the effect of the film-quality inhomogeneous portion.

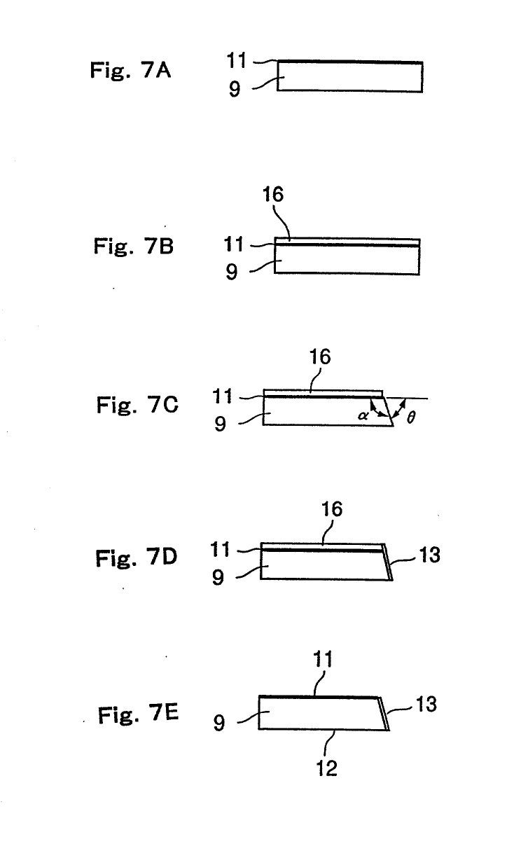

FIG. 7 shows one example of a method for fabricating a multiple reflecting device 8. This embodiment applies the fabricating method shown in the figure to fabricate a multiple reflecting device 8 thereby minimizing the film-quality inhomogeneous portion.

First, as shown in FIG. 7A, a first reflecting film 11 is formed in a first interface of a substrate 9. On the reflecting film 11, resist 16 is formed as shown in FIG. 17B. In this state, the substrate 9 at one end is worked to a set angle (angle a defined between the first interface 1 and the second interface 3).

This working is, generally, by polish. For example, assuming that the first reflecting film 11 has a thickness of 2 μm, the film-quality inhomogeneous portion can be made 30 μm or less by providing a polish angle θ (θ=180−α) with 5° or greater.

Next, as shown in FIG. 7D, a anti-reflection coating 13 is formed by deposition on the third interface 3 of the substrate 9. Finally, as shown in FIG. 7E, the resist 16 is removed away. This can form a precise multiple reflecting device 8 having a clear cut-line between the first interface 1 and the third interface 3 at the boundary B on the first interface 1 and third interface 3. Thereafter, a reflecting film 12 is formed on the second interface 2 of the substrate 9.

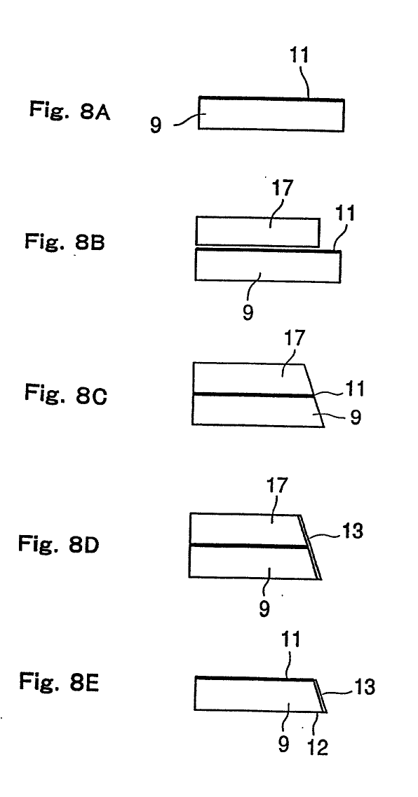

Meanwhile, it is possible to apply a fabrication method shown in FIG. 8. Namely, as shown in FIG. 8A, a first reflecting film 11 is formed on a first interface 1 of a substrate 9. On the reflecting film 11, a dummy substrate 17 is formed as shown in FIG. 8B. In this state, the substrate 9 at one end is worked to the set angle, to form a anti-reflecting coating 13 on a third interface 3 of the substrate 9 by deposition as shown in FIG. 8D. Finally, as shown in FIG. 8E, the dummy substrate 17 is removed. Note that, in also this case, a second reflecting film 12 is formed on the second interface 2 of the substrate 9.

By fabricating the multiple reflecting device 8 in the above method, a multiple reflecting device 8 can be fabricated without using an organic material such as adhesive. Accordingly, it is possible to prevent characteristic deterioration resulting from the deterioration of adhesive or the like and cope with high-output input light.

Next, explanation is made in detail on the form of light reflection within the multiple reflecting device 8 and light exit out of the multiple reflecting device 8, with reference to FIG. 2. In the figure, the incident angle of the light incident on the third interface 3 of the multiple reflecting device 8 is designated at φᵢₙ. In the case that the incident angle φ on the second interface 2 is taken constant, the incident angle φᵢₙ on the third interface 3 increases with increase in the polish angle θ. In the case of reducing the angle φ equal to smaller than 10°, where a glass material having a reflectance of 1.5 at a wavelength 1310 nm is used for the multiple reflecting device 8 as in this embodiment, the incident angle φᵢₙ on the third interface 3 takes a value in the same degree as the polish angle θ.

By the increase in the incident angle φᵢₙ, polarization characteristic appears in the intensity of the light incident on the interior of the substrate 9, making difficult to form a anti-reflecting coating onto the third interface 3. Usually, in the case of using a glass material, it is possible to form a anti-reflecting coating if the incident angle φᵢₙ is nearly 30°. Accordingly it is desired that the polish angle θ on the substrate 9 also is 30° or less.

Meanwhile, from the preferred polish-angle θ range of 5° or greater in view of reducing the boundary E between the first interface 1 and the third interface 3 of the multiple reflecting device 8, the angle θ is preferably 5° or greater but 30° or less. In this embodiment, the angle α defined between the first interface 1 and the third interface 3 is provided 160°, a value of 150° or greater but 175° or less.

Meanwhile, where incident light is incident at an angle φᵢₙ on the third interface, the incident light enters the interior of the multiple reflecting device 8 having an angle to the third interface 3 of φₒᵤₜ≈sin⁻¹ (sin (φᵢₙ)/n). Herein, n is a reflectance of the substrate 9 at a wavelength of light, which in this embodiment is approximately 1.5. The light ray will be incident at an angle φ=θ−φₒᵤₜ on the second interface 2.

Meanwhile, the light exiting at the second interface 2 will exit at an angle of φₒᵤₜ≈n·φ. Because the first interface 1 and the second interface 2 are parallel with each other, part of the incident light exits at the angle φₒᵤₜ each time the light reflects upon the second interface.

Meanwhile, because this embodiment is designed such that the beam waist of light collected by the anamorphic lens is nearly coincident with the position A₀ where the light first incident from the third interface on the second interface 2 of the multiple reflecting device 8, the light exiting at the position A₀ can be approximated nearly as diverging spherical wave in an interference direction nearby the optical axis thereof.

The exiting light at the second interface 2 can be approximated by the spherical waves respectively having a common base position A₀ and respectively exited at positions A₀, A₁, . . . on the second interface 2. Namely, the exit light from the multiple reflecting device 8, because of formed by interference between these of exiting light, can be determined by superposing the diverging spherical waves having the common base position A₀ and exited at the positions A₀, A₁, . . . on the second interface 2.

Herein, consideration is made on the light propagating along the center axis in an optical axis direction. Assuming that an optical path difference is ΔL (0) between a ray of light directly exiting at the position A₀ on the second interface 2 of the multiple reflecting device 8 to the outside of the multiple reflecting device 8 and a ray of light reflected at the position A₀ and then once reflected upon the first interface 1 and thereafter exiting at a position A₁ to the outside of the multiple reflecting device 8, ΔL (0) is expressed by the following Formula.

ΔL(0)=2n·d·cos φ . . . (1)

In order to mutually intensify the light ray directly exiting at the position A₀ and the light ray exiting at the position A₁, there is a need that ΔL (0) is integer times the wavelength. Because the difference in optical path length of every adjacent ray of light is similarly ΔL (0), the light exiting having an angle φₒᵤₜ from the multiple reflecting device 8, if its wavelength given λ, is required to satisfy the interference condition designated by the following Formula (2), where m is an integer.

2n·d·cos φ=m·λ (2)

Next, consideration is made on a ray of light propagating with inclination at an angle of Δφ to a center axis in an optical axis direction. If considering a optical path length difference similarly to the above, a light path length ΔL(Δφ) between a ray of light directly exiting at the position A₀ and a ray of light exiting at the position A₁′ is expressed by the following Formula (3). Meanwhile, the exit angle at each position A0, A1, . . . exits with an angle difference Δφₒᵤₜ from an exit angle φₒᵤₜ of the light propagating along the center axis in the optical axis direction (through the path shown by the broken lines in the figure). This angle difference is expressed by Formula (4).

ΔL(Δφ)=2n·d·cos(φ+Δφ) (3)

Δφ≅n·Δφ (4)

Incidentally, Formula (4) holds for the case that φ, Aφ, φₒᵤₜ and Δφₒᵤₜ are small and sin (φ+Δφ) and sin (φₒᵤₜ+Δφₒᵤₜ) are to be approximated to φ+Δφ and φₒᵤₜ+Δφₒᵤₜ. This embodiment satisfies this condition.

The exit angle at the second interface 2 of the multiple reflecting device 8 varies by a variation amount expressed in Formula (Equation 1) in accordance with a wavelength.

$$\frac{ⅆ φ out}{ⅆ λ} = - \frac{{n}^{2}}{λ \cdot sin φ out} \qquad [ Equation 1 ]$$

This embodiment is set with an incident angle φᵢₙ=2.4° and d=500 μm. For example, in the case that the incident light has a wavelength band of at around 1310 nm and the exit light at an angle φₒᵤₜ having a wavelength 1310 nm to satisfy the foregoing interference condition, an exit-angle change amount Δφₒᵤₜ due to wavelength change is approximately −0.88 (°/nm) at around φₒᵤₜ≈6.41°.

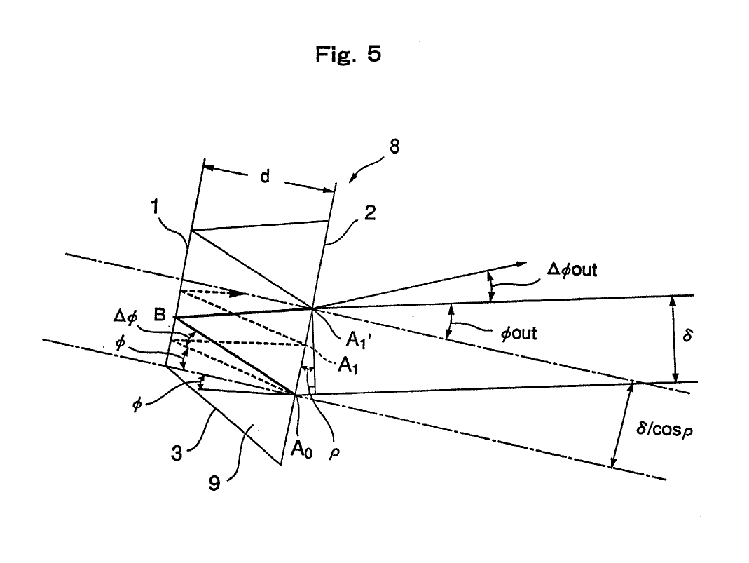

Next, explanation is made, in this embodiment, on the arrangement of the second lens 7 and the amount of chromatic dispersion. First, it is assumed that the second lens in its center line C has a height σ when taking the position A₀ as a reference as shown in FIG. 4 and a ray of right exiting at an angle Δφ to a center axis of an optical axis direction after multiple-reflection between the first interface 1 and second interface 2 of the multiple reflecting device 8 has a light exit position A′ having a height of δ as shown in FIG. 5. Note that, in also FIG. 5, the broken line denotes a light traveling path along a center axis in an optical axis direction.

Herein, as shown in FIG. 5, the multiple reflecting device 8 is arranged such that the second interface 2 of the multiple reflecting device 8 inclines at an angle ρ to the center line of the second lens 7. In this embodiment, ρ=φₒᵤₜ=6.41°.

The optical path length D that the incident light upon rising a height δ travels in the interior of the light multiplex reflector 8 due to reflection is expressed by the following Formula (5).

D1(δ,φ)=(n·δ)/(sin φ·cos ρ) (5)

Herein, in the case that the light traveled with deviation Δφ from the light center axis in the multiple reflecting device 8 exits at a position A₁′ at a height δ of the multiple reflecting device 8, passes the second lens 7 and then reflected upon the reflecting element 4 and returned to a position Aₕ again through the second lens 7, provided that the height of the position Aₕ with respect to the center C of the second lens 7 is h1, the height h1 is expressed by the following Formula (6).

h1=2(f−L)·Δφₒᵤₜ+σ−δ (6)

Incidentally, in Formula (6), f is a distance between the second lens 7 and the light reflecting element 4, which in this embodiment is a focal length of the second lens. L represents a distance between the multiple reflecting device 8 and the second lens 7 (more specifically, a distance between the position A₀ and the second lens).

Meanwhile, the overall optical path length OPL of the light exited at the position A₀ of the multiple reflecting device 8 and returned to the position A₀ (φ+Δφ) is expressed by the following Formula (Equation 2).

OPL(φ+Δφ)=D1(δ,φ+Δφ)+2f+2L+D1(h1+σ,φ+Δφ)=2L+2f+2n[n(f−L)·Δφ+σ]/sin(φ+Δφ)·cos ρ [Equation 2]

The amount of dispersion (chromatic dispersion value) Dp, obtained by dividing a wavelength differentiation value by the light velocity c, is expressed by the following formula (Equation 3).

$$\begin{matrix}Dp = \frac{ⅆ OPL}{c \cdot ⅆ λ} = \frac{1}{c} \cdot \frac{ⅆ OPL}{ⅆ φ} \cdot \frac{ⅆ {φ}_{out}}{ⅆ λ} \cdot \frac{ⅆ φ}{ⅆ {φ}_{out}} \\ = - \frac{n}{λ \cdot sin {φ}_{out}} \cdot \frac{1}{c} \cdot \frac{ⅆ OPL}{ⅆ φ} \\ = - \frac{2 {n}^{4} [ ( f - L ) - \frac{σ \cdot cot ( \frac{{φ}_{out}}{n} )}{n} ]}{λ \cdot c \cdot {sin}^{2} {φ}_{out} \cdot cos ρ}\end{matrix} \qquad [ Equation 3 ]$$

As can be seen from (Equation 3), the amount of dispersion Dp relies on a distance L between the multiple reflecting device 8 and the second lens 7. Accordingly, provided for example that L is 5 mm, f is 200 and the height σis 2 mm, the dispersion at a wavelength of 1.31 μm can be given a value of approximately −368 psec./nm.

The present embodiment is structured as above. If the light introduced by the input/output waveguide element 5 is incident on the multiple reflecting device 8 through the first lens 6, the light travels while multiple-reflecting on the first interface 1 and second interface 2 of the multiple reflecting device 8. When the light reflects upon the second interface, part of the light exits at the second interface 2. By the mutual interference of the light exited each time reflection occurs at the second interface, an exit light from the multiple reflecting device 8 is formed.

The exit light incident on the light reflecting element 4 through the second lens 7 and reflects on the light reflecting element 4, and then returns to the multiple reflecting device 8 through the second lens 7. This returning light is incident on the second interface 2 of the multiple reflecting device 8. Because the incidence position and angle is different depending on a wavelength of light, the time required for returning through the multiple reflecting device 8 is different depending on a wavelength, thus causing chromatic dispersion.

In this embodiment, the amount of chromatic dispersion is determined by the above formula (Equation 3). Accordingly, by properly setting a distance between the multiple reflecting device 8 and the second lens 7, a height σ in the center C of the second lens 7, for example, with a light transmission line such as an optical fiber to be applied in wavelength-division multiplex transmission, it is possible to compensate for the chromatic dispersion in a mate of connection on an optical fiber.

Meanwhile, the present embodiment, simple in structure as shown in FIG. 1, can be easily fabricated and further made as a variable group delay unit reduced in size.

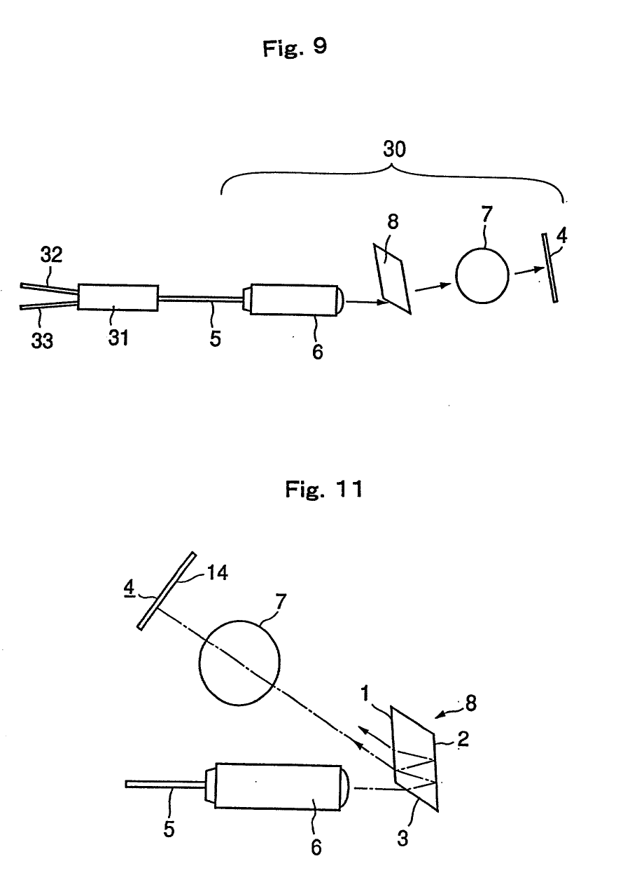

FIG. 9 shows a structural example of a variable group delay module having the variable group delay unit of the present embodiment. In the figure, the variable group delay unit is designated with a reference numeral 30. The variable group delay module shown in the figure has a variable group delay unit 30 of the foregoing embodiment, an optical coupling element 31 to be optically coupled to the input/output waveguide element 5 of the variable group delay unit 30, a light introducing element 32 to introduce light to the input/output waveguide element 5 through the optical coupling element 31, and a light deriving element 33 for deriving the exit light from the input/output waveguide element 5 through the optical coupling element 31. Note that, herein, the optical coupling element is an optical circulator.

The light introducing element 32 and light deriving element 33 can be formed, for example, of a single-mode optical fiber. The single-mode optical fiber is connected to a mate of connection such as an optical transmission line. This allows the light propagated the optical component on the mate of connection is introduced to the variable group delay unit 30 through the light introducing element 32 and optical coupling element 31, thus propagating through the variable group delay unit 30. Then, the light propagated the variable group delay unit 30 is returned to the mate of connection through the optical coupling element 31 and light deriving element 33. This can compensate for chromatic dispersion on the mate of connection.

Next, explanation is made on a second embodiment of a variable group delay unit of the invention. Note that, in the explanation of the second embodiment, duplicated explanation with the first embodiment is omitted.

The second embodiment is nearly similarly structured to the first embodiment. The feature of the second embodiment different from the first embodiment lies in that an optical-part moving device is provided to vary the distance between the second lens 7 and the multiple reflecting device 8. The optical-part moving device is formed, for example, by a stepping motor and ball screw.

As in the foregoing, in the variable group delay unit structured similarly to the first embodiment, the amount of dispersion Dp relies upon the distance L between the multiple reflecting device 8 and the second lens 7. Accordingly, by varying the distance between the second lens 7 and the multiple reflecting device 8 due to the optical part moving device as in the second embodiment, the amount of dispersion caused in the variable group delay unit can be varied.

In the second embodiment, the optical-part moving device is structured to vary the distance L between the multiple reflecting device 8 and the second lens 7 in a range of from 5 mm to 200 mm. The chromatic dispersion value is approximately 37 psec./nm when the distance L is 200 mm at the wavelength λ=1.31 μm. Meanwhile, because the chromatic dispersion value is approximately −368 psec./nm when the distance L is 5 mm at a wavelength λ=1.31 μm as in the foregoing, the second embodiment can variably adjust the dispersion amount in a range of approximately 400 psec./nm.

The second embodiment structured above can provide effects similarly to the first embodiment. Also, because the second embodiment can vary dispersion amount as in the foreging, dispersion amount after the manufacture of a variable group delay unit can be varied to the optical part of a mate of connection (correspondingly to a component dispersion compensation amount), thus enabling adaptation in a flexible fashion.

Next, explanation is made on a third embodiment of a variable group delay unit according to the invention. The third embodiment is similarly structured to the second embodiment. The feature of the third embodiment different from the second embodiment lies in that, as shown in FIG. 10, the light reflecting element 4 is formed by a curved surface such as a spherical surface in a region where the input light from the second lens 7 incident (herein, reflecting surface 14). In also the third embodiment, this region (light incident region) is formed with a reflection film having a reflectance of 90% or higher for a set wavelength.

In the third embodiment structured as above, in the case that the light traveling at an angle deviated by Δφ from a center axis of the traveling light through the light multiplex reflector 8 exits a position A1′ at a height δ of the multiple reflecting device 8 to travel through the second lens 7 and reflects upon the reflecting element 4 and then returns to a position Aₕ again through the second lens 7, a height h2 is expressed by the following Formula (7) provided the height with respect to the center axis of the second lens 7 is h2.

h2=2[(f−L)+f²/R]·Δφₒᵤₜ+σ−δ (7)

Also, the overall optical path length of the light exited at the position A₀ of the multiple reflecting device 8 and returned to the position A₀ is expressed by the following formula (Equation 4).

OPL(φ+Δφ)=D1(δ,φ+Δφ)+2f+2L+D(h2+σ,φ+Δφ) [Equation 4]

The amount of dispersion (chromatic dispersion value) Dp is expressed by the following formula provided that the radius of curvature for the surface of the light reflecting element 4 is R (Equation 5).

$$Dp = - \frac{2 {n}^{4} [ ( f - L ) - \frac{σ \cdot cot ( \frac{{φ}_{out}}{n} )}{n} + \frac{{f}^{2}}{R} ]}{λ \cdot c \cdot {sin}^{2} {φ}_{out} \cdot cos ρ} \qquad [ Equation 5 ]$$

Provided, for example, that R is 10 mm and the height σ is 2 mm, the dispersion value at a wavelength 1.31 μm can be given approximately −8689 psec./nm when the distance L between the multiple reflecting device 8 and the second lens 7 is 5 mm. If the distance L is 200 mm, the dispersion value at a wavelength 1.32 μm can be approximately −8283 psec./nm.

In this manner, the third embodiment can provide the similar effects to the second embodiment. The adjusting amount of the dispersion amount by the variable group delay unit of the third embodiment is similar to that of the second embodiment, wherein dispersion compensation amount in absolute value can be increased.

Incidentally, the invention is not limited to the foregoing embodiments but can take various forms. For example, although the second and third embodiments had the optical part moving device to vary the distance between the multiple reflecting device 8 and the second lens 7, the similar effect is provided if the optical part moving device is structured to vary the distance between at least one of the second lens 7 and the light reflecting element 4 and the multiple reflecting device 8.

Also, although the third embodiment had a spherical surface in the reflecting surface 14 of the light reflecting element 4, it may be a curve surface other than a spherical surface.

Furthermore, although in the foregoing embodiments the multiple reflecting device 8 was made by a light multiplexing reflecting plate having the glass substrate 9, the multiple reflecting device 8 is not necessarily limited to a light multiplexing reflecting plate but may be a multiple reflecting device 8 other than in the plate form. Meanwhile, in the case of making the multiple reflecting device 8 as a light multiplexing reflecting plate, the substrate thereof is not necessarily limited to a glass substrate 9 but can be made as a light multiplexing reflecting plate having as a substrate 9 a crystal transparent for a use wavelength of light (optically transparent), e.g. silica. Note that the glass substrate has a merit easiest in fabrication.

Furthermore, the foregoing embodiments were structured that the light introduced by the input/output waveguide element is incident on the third interface 3 and exited at the third interface 3 of the multiple reflecting device 8 while the light reflected by the light reflecting element 4 is incident on the second interface 2 and exited at the third interface 3. However, as shown in FIG. 11, the structure may be such that the light introduced by the input/output waveguide element 5 and incident on the third interface 3 of the multiple reflecting device 8 is exited at the first interface 1 while the light reflected by the light reflecting element 4 is incident on the first interface 1 and exited at the third interface 3.

In this case, it is preferred to form, for example, a reflecting film having a reflectance of 99% or higher for a set wavelength band on the second interface 2 of the multiple reflecting device 8 and a reflecting film having a reflectance of 60% or higher for the set wavelength band on the first interface 1.

Furthermore, although in the foregoing embodiment the angle α defined between the first interface 1 and the third interface 3 of the multiple reflecting device 8 was 160° as a value within a range of from 150° or greater to 175° or smaller, the angle α is not limited to 160° but may be any value within the range. Meanwhile, although the angle α is preferably a value within the range of from 150° or greater to 175° or smaller, the angle α may be a value within the range of from 90° or greater to 180° or smaller.

Furthermore, although in the foregoing embodiment the input/output waveguide element 5 was made by a single-mode optical fiber, the input/output waveguide element 5 may be formed by any one of a multi-mode optical fiber, a grated index optical fiber, a dispersion shift optical fiber, a polarization maintaining optical fiber and a planar waveguide.

What is claimed is:

1. A variable group delay unit comprising:
an input/output waveguide element for introducing and deriving light;
a light reflecting element arranged with a spacing to said input/output waveguide element to reflect light;
a multiple reflecting device provided on an optical path in which a light introduced by said input/output waveguide element reflects upon said light reflecting element and returns to said input/output waveguide element;
a first lens provided on the optical path between said multiple reflecting device and said input/output waveguide element; and
a second lens provided on the optical path between said multiple reflecting device and said light reflecting element;
whereby said multiple reflecting device has a first interface facing to said first lens and a second interface as a surface opposite thereto that are parallel with each other to multiple-reflect a light incident on said multiple reflecting device by said first interface and second interface, said multiple reflecting device having a third interface having a slant surface at an angle of from 90 degrees or more to 180 degrees or less to said first interface.

2. A variable group delay unit according to claim 1, wherein a light introduced by said input/output waveguide element is incident on the third interface of said multiple reflecting device and exited at the first interface or second interface, a light reflected by said light reflecting element being incident on the first interface or second interface and exited at the third interface.

3. A variable group delay unit according to claim 1, wherein said multiple reflecting device has an angle ranging from 150 degrees or more to 175 degrees or less defined between the first interface and the third interface.

4. A variable group delay unit according to claim 1, wherein said light multiplex reflector has a anti-reflection coating for a light at a set wavelength band formed in a region to pass light and on the third interface a reflection film having a reflectance of 60% or more at a set wavelength band formed at least in a region to pass or reflect light on the first interface and second interface.

5. A variable group delay unit according to claim 1, wherein the first interface and said second interface of said light multiplex reflector are formed by working both surfaces of a substrate transparent at a wavelength band used.

6. A variable group delay unit according to claim 1, wherein said first lens has an anamorphic lens to make a light traveling while reflecting within said multiple reflecting device such that a spot diameter in an interference direction thereof is smaller than a spot diameter in a direction orthogonal to the interference direction.

7. A variable group delay unit according to claim 1, wherein said input/output waveguide element is formed by any one of a single-mode optical fiber, a multi-mode optical fiber, a grated index optical fiber, a dispersion shift optical fiber, a polarization maintaining optical fiber and a planar waveguide.

8. A variable group delay unit according to claim 1, wherein said first lens and said second lens are formed by combining one or more of a ball lens, a spherical lens, a graded refractive index lens, an aspherical lens, a cylindrical lens, a multi-mode grated fiber lens and an anamorphic prism, and have a anti-reflection coating for a set wavelength formed on a surface that light is to be incident.

9. A variable group delay unit according to claim 1, wherein said light reflecting element is formed with a planar surface in a region where an exit light from said second lens is incident, a reflection film having a reflectance of 90% or more for a set wavelength band being formed in the region.

10. A variable group delay unit according to claim 1, wherein said light reflecting element is formed with a curved surface in a region where an exit light from said second lens is to be incident, a reflection film having a reflectance of 90% or more for a set wavelength band being formed in the region.

11. A variable group delay unit according to claim 8, wherein said first lens is structured by a composite lens having at least two kinds of lens, said composite lens at least having said collimate lens to make a light exited from said input/output waveguide element into a parallel light and an anamorphic lens to make a light traveling while reflecting within said multiple reflecting device such that a spot diameter in an interference direction thereof is smaller than a spot diameter in a direction orthogonal to the interference direction.

12. A variable group delay unit according to claim 1, wherein an optical part moving device is provided to vary a distance between at least one of said second lens and said light reflecting element and said multiple reflecting device.

13. Having a variable group delay unit according to claim 1, an optical coupling device for optically coupling to an input/output waveguide element of said variable group delay unit, a light introducing element for introducing light to said input/output waveguide element through said optical coupling device, and a light deriving means for deriving an exit light from said input/output waveguide element through said optical coupling device.
